(19) United States
(12) Patent Application Publication
(10) Pub. No.: US 2006/0294177 A1
(43) Pub. Date: Dec. 28, 2006

(54) Method, system and apparatus of performing division operations

(76) Inventor: Simon Rubanovich, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/166,140

(22) Filed: Jun. 27, 2005

(51) Int. Cl. G06F 7/52

(52) U.S. Cl. 708/650

(57) ABSTRACT

Embodiments of the present invention provide a method, apparatus and system of dividing a first number by a second number. Some demonstrative embodiments include generating a first value relating to the first number; generating a second value corresponding to a remainder of a division of the number one by the second number; and dividing the first value by the second value. Some demonstrative embodiments include generating a plurality of independent interim values by adding at least first and second sets of one or more carry bits of an encoded remainder value corresponding to a cycle of a division operation to at least first and second sets of one or more sum bits of the encoded remainder value, respectively; and generating a plurality of coefficients corresponding to a quotient digit of the cycle based on the plurality of interim values. Other embodiments are described and claimed.

### BACKGROUND OF THE INVENTION

A divider may determine a quotient, denoted “Q”, corresponding to a division of a dividend, denoted “P”, by a divisor, denoted “D”.

A conventional divider may implement a division algorithm, e.g., a Sweeney, Robertson and Tocher (SRT) division algorithm, including a series of division cycles, each for determining a quotient based on a partial remainder of a previous cycle and a quotient digit.

Conventional dividers may include a quotient-digit selection logic (QSL) for generating the quotient digit according to a partial remainder value from a previous division cycle, for example, based on a predetermined PD-Plot.

### BRIEF DESCRIPTION OF THE DRAWINGS

The subject matter regarded as at least one embodiment of the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings in which:

FIG. 1 is a schematic illustration of a system including a divider arrangement in accordance with some demonstrative embodiments of the present invention;

FIG. 2 is a schematic illustration of a dividend value generator configuration in accordance with some demonstrative embodiments of the invention;

FIG. 3 is a schematic block diagram illustration of a method of dividing a first number by a second number in accordance with some demonstrative embodiments of the invention;

FIG. 4 is a schematic illustration of a divider including a quotient digit selector and an encoded remainder generator in accordance with some demonstrative embodiments of the invention;

FIG. 5 is a schematic illustration of a quotient-digit coefficient generator in accordance with some demonstrative embodiments of the invention; and

FIG. 6 is a schematic block diagram illustration of a method of generating one or more bits corresponding to a quotient digit in accordance with some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of embodiments of the invention. However, it will be understood by those of ordinary skill in the art that embodiments of the present invention may be practiced without these specific details. In other instances, well-known methods, procedures, components and circuits may not have been described in detail so as not to obscure embodiments of the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

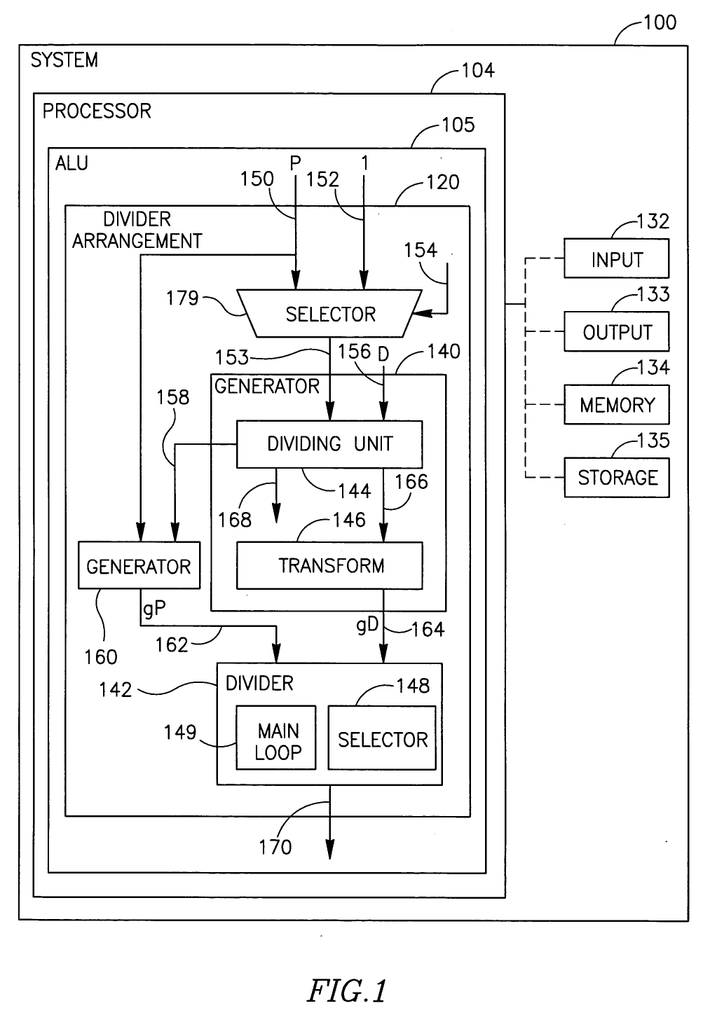

Reference is made to FIG. 1, which schematically illustrates a system 100 in accordance with some demonstrative embodiments of the present invention.

According to some demonstrative embodiments, system 100 may include a processor 104. Processor 104 may include, for example, a central processing unit (CPU), a digital signal processor (DSP), a microprocessor, a host processor, a plurality of processors, a controller, a chip, a microchip, or any other suitable multi-purpose or specific processor or controller.

According to some demonstrative embodiments of the invention, system 100 may also include an input unit 132, an output unit 133, a memory unit 134, and/or a storage unit 135. System 100 may additionally include other suitable hardware components and/or software components. In some embodiments, system 100 may include or may be, for example, a computing platform, e.g., a personal computer, a desktop computer, a mobile computer, a laptop computer, a notebook computer, a terminal, a workstation, a server computer, a personal digital assistant (PDA) device, a tablet computer, a network device, a micro-controller, a cellular phone, a camera, or any other suitable computing and/or communication device.

Input unit 132 may include, for example, a keyboard, a mouse, a touch-pad, or other suitable pointing device or input device. Output unit 133 may include, for example, a cathode ray tube (CRT) monitor, a liquid crystal display (LCD) monitor, or other suitable monitor or display unit.

Storage unit 135 may include, for example, a hard disk drive, a floppy disk drive, a compact disk (CD) drive, a CD-recordable (CD-R) drive, or other suitable removable and/or fixed storage unit.

Memory unit 134 may include, for example, a random access memory (RAM), a read only memory (ROM), a dynamic RAM (DRAM), a synchronous DRAM (SD-RAM), a Flash memory, a volatile memory, a non-volatile memory, a cache memory, a buffer, a short term memory unit, a long term memory unit, or other suitable memory units or storage units.

According to some demonstrative embodiments of the invention, processor 104 may include at least one arithmetic logic unit (ALU) 105. ALU 105 may include at least one divider arrangement 120 to determine a quotient, denoted “Q”, corresponding to a division of a first number (also referred to as “the dividend”), denoted “P”, by a second number (also referred to as “the divisor”), denoted “D”, as describe below.

According to some demonstrative embodiments of the invention, divider arrangement 120 may include a divisor value generator 140, a dividend value generator 160, and a divider 142, as described in detail below.

Generator 140 may generate signals 164 corresponding to a value, denoted “gD”, which corresponds to the divisor D. Generator 160 may generate signals 162 corresponding to a value, denoted “gP”, which corresponds to the dividend P. The value gD may correspond, for example, to a product of the divisor D and an approximate reciprocal, denoted g, of the divisor D. The value gP may correspond, for example, to a product of the dividend P and the approximate reciprocal g, as described below.

According to demonstrative embodiments of the invention, divider 142 may generate signals 170 corresponding to a division of the dividend P by the divisor D, by dividing the value gP of signals 162 by the value gD of signals 164. For example, divider 142 may implement a division algorithm, e.g., a Sweeney, Robertson and Tocher (SRT) division algorithm as is known in the art, for performing a series of x division cycles. A quotient Qₘ₊₁ of a division cycle m+1, m=0 . . . x−1, may be determined, for example, using the following recursive equations:
R₀=gP, Q₀=0 (1)
Rₘ₊₁=rRₘ−qₘ₊₁(gD) (2)
Qₘ₊₁=rQₘ+qₘ₊₁ (3)
wherein Rₘ denotes a partial remainder value corresponding to a previous cycle m, qₘ₊₁ denotes a quotient digit corresponding to cycle m+1, Rₘ₊₁ denotes a partial remainder value corresponding to cycle m+1, Qₘ denotes a quotient corresponding to cycle m, and r denotes a radix of divider 142. The radix r may be determined, for example, by the following equation:
r=2^{ρ} (4)
wherein ρ denotes a value related to the number of bits of the quotient digit qₘ₊₁.

According to some demonstrative embodiments of the invention, divider 142 may include a quotient digit selector 148 to generate quotient digit qₘ₊₁.

According to some demonstrative embodiments of the invention, divider 142 may include a high-radix divider, for example, having a radix of at least four, e.g., a radix of 256. Accordingly, quotient digit selector 148 may generate two or more bits, e.g., eight bits, representing quotient digit qₘ₊₁, e.g., as described below.

According to some demonstrative embodiments of the invention, quotient digit selector 148 may generate a plurality of independent interim values by adding at least first and second sets of one or more carry bits of an encoded remainder value corresponding to cycle m+1 to at least first and second sets of one or more sum bits of the encoded remainder value, respectively; and to generate a plurality of coefficients corresponding to quotient digit qₘ₊₁ based on the plurality of interim values. Quotient digit selector 148 may also generate one or more bits corresponding to the quotient digit qₘ₊₁ by combining two or more of the plurality of coefficients, e.g., as described in detail below.

According to other embodiments of the invention, quotient digit selector 148 may include any other suitable quotient digit selector, e.g., as known in the art.

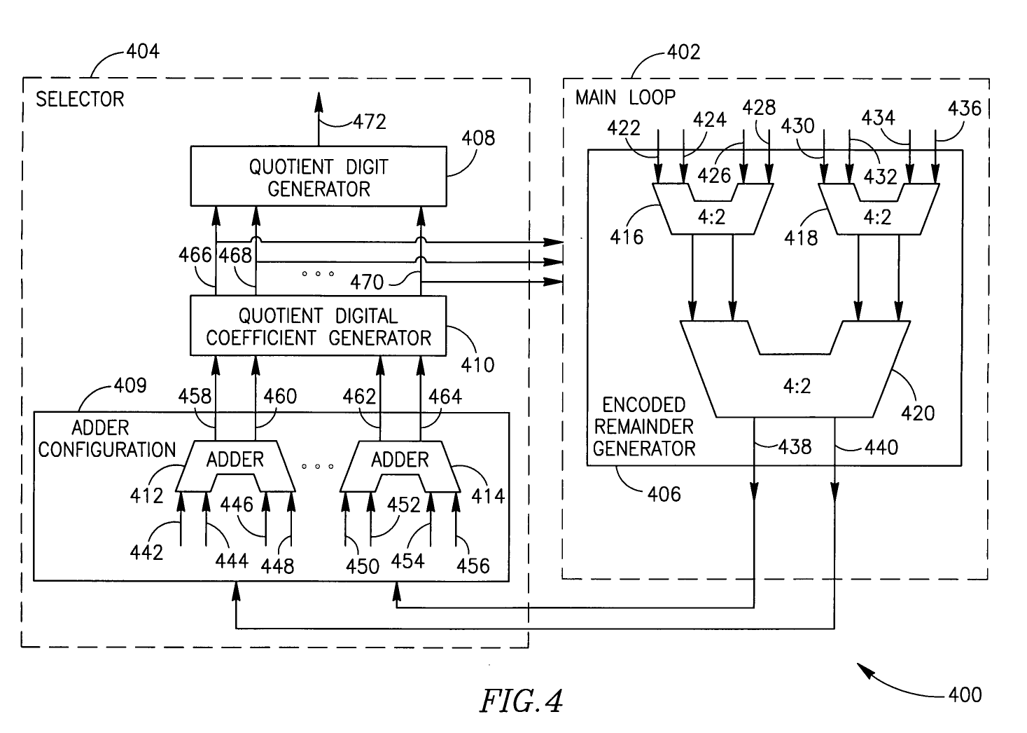

According to some demonstrative embodiments of the invention, divider 142 may also include a main loop module 149 to determine the quotient Qₘ₊₁ and/or the partial remainder Rₘ₊₁, e.g., in accordance with Equations 1, 2, and/or 3. According to some demonstrative embodiments of the invention, main loop 149 may be able to generate one or more signals corresponding to the encoded-remainder value, e.g., as described below with reference to FIG. 4. Additionally or alternatively, main loop module 149 may include any suitable configuration, for example, a configuration including one or more adders, multiplexers, carry-save-adders (CSAs), latches, flip flop units, and/or any other element, e.g., as is known in the art.

According to some demonstrative embodiments of the invention, generator 140 may generate signals 164 by applying a predetermined transformation to a remainder value corresponding to a division of the number one by the divisor D, e.g., as described below. However, it will be appreciated by those skilled in the art, that according to other embodiments of the invention, generator 140 may include any other suitable configuration, for example, including a memory to store a reciprocal look-up-table, one or more multipliers, and/or any other hardware for generating the value gD, e.g., as is known in the art.

According to some demonstrative embodiments of the invention, generator 140 may include a dividing unit 144 and a transformation configuration 146. Dividing unit 144 may generate one or more signals corresponding to a division of two numbers by performing a predetermined number, denoted “j”, of division cycles corresponding to a division algorithm, e.g., a SRT division algorithm. For example, dividing unit 144 may receive signals 156, e.g., corresponding to the divisor D, and signals 153 corresponding to another number to be divided by the divisor D. Dividing unit 144 may be able to determine a remainder, denoted “R′ₘ”, of a division cycle m′, m′=1 . . . j−1; and a quotient, denoted “Q′ₘ” resulting from division cycle m′, e.g., as described below. Dividing unit 144 may generate signals 166 corresponding to a remainder, R′ⱼ, and signals 168 corresponding to the quotient Q′ⱼ, after performing j division cycles. The number of cycles performed by dividing unit 144 may be determined based on any suitable criteria, e.g., as described below. Dividing unit 144 may include, for example, a low-radix divider, e.g., a divider having a radix of two. In other embodiments, dividing unit 144 may include any other suitable divider, e.g., having a radix of four, eight, sixteen, or any other suitable radix.

According to some demonstrative embodiments of the invention, dividing unit 144 may be provided with signals 153 having a value corresponding to the number one, e.g., as described below.

According to some demonstrative embodiments of the invention, divider arrangement 120 may be selectively switched between first and second division configurations, as described in detail below. For example, the first division configuration of divider arrangement 120 may perform a low-radix division operation, e.g., a low-radix integer division, and/or any other operation, e.g., a low-radix square root operation, corresponding to divisor D and dividend P. The second configuration of divider arrangement 120 may perform a high-radix division operation corresponding to divisor D and dividend P.

According to some demonstrative embodiments of the invention, divider arrangement 120 may selectively provide dividing unit 144 with input signal 153 having a value corresponding either to the number one or to the dividend P. For example, divider arrangement 120 may include a selector 179 to receive signals 150 and 152 having values corresponding to the dividend P and the number one, respectively; and to selectively provide dividing unit 144 with signals 153 having a value corresponding to either signals 150 or signal 152, e.g., based on a control signal 154.

According to some demonstrative embodiments of the invention, control signal 154 may be used to control selector 179 to select either signals 150 or 152, e.g., in accordance with a desired operation to be performed by divider arrangement 120, as described below.

According to some demonstrative embodiments of the invention, it may be desired to perform a division operation corresponding to the division of the dividend P by the divisor D, e.g., as part of a square root operation or an integer division operation, which may be performed, for example, using a low-radix divider. Accordingly, selector 179 may be controlled, e.g., using signal 154, to provide dividing unit 144 with signals 153 corresponding to the value of dividend P. Thus, signals 168 and 166 may have values corresponding to the quotient and dividend of the division of the dividend P by the divisor D.

Alternatively, it may be desired to perform one or more division cycles corresponding to the division of the number one by the divisor D, e.g., in order to generate signals 164. Accordingly, selector 179 may be controlled, e.g., using signal 154, to provide dividing unit 144 with signals 153 corresponding to the value of signals 152. Thus, signals 168 and 166 may have values corresponding to the quotient and remainder of the division of the number one by the divisor D.

According to some demonstrative embodiments of the invention, transformation configuration 146 may generate signals 164 corresponding to the value gD by applying a predetermined transformation to signals 166, for example, if signals 153 correspond to the number one and signals 166 correspond to the remainder R′ⱼ, e.g., as described below.

According to some demonstrative embodiments of the invention, dividing unit 144 may determine a quotient Q′ₘ₊₁ of a division cycle m+1, for example, using the following recursive equations, e.g., when divider is provided with signals 153 corresponding to the number one and signals 156 corresponding to the divider 156:
R′₀=1, Q′₀=0 (5)
R′₁=r₀R′₀−q′₁D (6)
Q′₁=r₀Q′₀+q′₁ (7)
R′_{m′+1}=r′R′_{m′}−q′_{m′+1}D (8)
Q′_{m′+1}=r′Q′_{m′}+q′_{m′+1} (9)
wherein, q′_{m′+1} denotes a quotient digit corresponding to cycle m′+1, R′_{m′+1} denotes a partial remainder value corresponding to cycle m′+1, and r′ denotes a radix of dividing unit 144. The radix r′ may be determined, for example, by the following equation:
r′=2^{ρ′} (10)
wherein ρ′ denotes a value related to the number of bits of the quotient digit q′_{m′+1}; and wherein r₀ denotes a pre-processing radix corresponding to a preprocessing stage, which may be performed, for example, to determine k≧0 quotient bits, e.g., as is known in the art The radix r₀ may be determined, for example, by the following equation:
r₀=2^{k} (11)

According to some demonstrative embodiments the following equation may be derived from Equations 5-9, e.g., by induction as described below:
R′_{m′}=(r′)^{m-1}r₀−DQ′_{m′} (12)

According to some demonstrative embodiments of the invention, the following equations may be derived from Equations 5-9:
R′₁=r₀R′₀−q′₁D=r₀−Q′₁D (13)
R′₂=r′R′₁−q′₂D=r′r₀−r′Q′₁D−q′₂D=r′r₀−D(r′Q′₁D+q′₂)=r′r₀−DQ′₂ (14)

Thus, Equation 13 may indicate that Equation 12 is true for m′=1.

The following Equation may be derived from Equation 8, e.g., assuming that Equation 12 is correct:

$${R}_{{m}^{′} + 1}^{′} = {r}^{′} {R}_{{m}^{′}}^{′} - {q}_{{m}^{′} + 1}^{′} D = {r}^{′} [ {( {r}^{′} )}^{m - 1} {r}_{0} - {DQ}_{{m}^{′}}^{′} ] - {q}_{{m}^{′} + 1}^{′} D \\ = {( {r}^{′} )}^{m} {r}_{0} - D ( {r}^{′} {Q}_{{m}^{′}}^{′} + {q}_{{m}^{′} + 1}^{′} ) = {( {r}^{′} )}^{m} {r}_{0} - {DQ}_{{m}^{′} + 1}^{′} \qquad ( 15 )$$

It is noted from Equations 13 and 15 that Equation 12 is correct for m′=1; and for m′+1, if it is correct for m′. Thus, Equation 12 may be correct for every m′.

According to demonstrative embodiments of the invention, Equation 12 may be rewritten as follows:

$$\frac{{( {r}^{′} )}^{1 - m}}{{r}_{0}} {Q}_{{m}^{′}}^{′} D = 1 - \frac{{( {r}^{′} )}^{1 - {m}^{′}}}{{r}_{0}} {R}_{{m}^{′}}^{′} \qquad ( 16 )$$

An absolute value of the partial remainder, e.g., in the SRT division algorithm, is smaller than the absolute value of the divisor D, which in turn is smaller than two. Accordingly, the absolute value of the remainder R′_{m′} may be smaller than two. Thus, according to some demonstrative embodiments of the invention, the following may be correct for R′_{m′};

$$\vert \frac{{( {r}^{′} )}^{1 - {m}^{′}}}{{r}_{0}} {R}_{{m}^{′}}^{′} \vert < 2 * {2}^{ρ ( 1 - {m}^{′} ) - k} \qquad ( 17 )$$

According to Equation 17, the value of

$$\vert \frac{{( {r}^{′} )}^{1 - {m}^{′}}}{{r}_{0}} {R}_{{m}^{′}}^{1 - {m}^{′}} \vert$$

may be relatively very small, e.g., the value of

$$\vert \frac{{( {r}^{′} )}^{1 - {m}^{′}}}{{r}_{0}} {R}_{{m}^{′}}^{1 - {m}^{′}} \vert$$

may tend to zero as the value of m′ grows.

According to some demonstrative embodiments of the invention, the number j of division cycles performed by dividing unit 144 may be determined such that after the j-th division cycle:

$$\vert \frac{{( {r}^{′} )}^{1 - j}}{{r}_{0}} {R}_{j}^{′} \vert < 2 * {2}^{ρ ( 1 - f ) - k} << 1 \qquad ( 18 )$$

Accordingly, equation 16 may be rewritten as follows:

$$\frac{{( {r}^{′} )}^{1 - j}}{{r}_{0}} {Q}_{j}^{′} D \approx 1 \qquad ( 19 )$$

Thus, according to some demonstrative embodiments of the invention, the value of g may be determined according to the following equation:

$$g \approx 1 / D = \frac{{( {r}^{′} )}^{1 - j}}{{r}_{0}} {Q}_{j}^{′} \qquad ( 20 )$$

Substituting Equation 20 into Equation 16 may yield the following equation, which may be used, for example, to determine the value gD:

$$gD = 1 - \frac{{( {r}^{′} )}^{1 - j}}{{r}_{0}} {R}_{j}^{′} \qquad ( 21 )$$

According to some demonstrative embodiments of the invention, transformation module 146 may generate signals 164 by applying to the remainder value R′ⱼ of signals 166 a transformation based on Equation 21, e.g., as described below.

According to some demonstrative embodiments of the invention, the value (−R′ⱼ) may be expressed using the following binary representation:
−R′ⱼ=sp₀.p₋₁p₋₂. . . p₋ₙ (22)

Applying the transformation of Equation 21 to the representation of Equation 22 may yield the following representation of gD:
gD=0s′.s₁s₂ . . . s_{c}p₀p₋₁p₋₂ . . . p₋ₙ (23)
wherein s′ denotes the inversion of s (i.e., s′=1−s), s₁=s₂= . . . =s_{c}=s; and wherein the number c of bits after the fixed point in Equation 23 having the value s may be determined, for example, as follows:
c=p(j−1)+k−2 (24)

Thus, for example, transformation module 146 may include a configuration, e.g., a hardware configuration, for generating signals 146 according to Equation 23. For example, transformation module 146 may include suitable hardware, e.g., an inverter, for generating s′ based on the value s of signal 166; and suitable hardware, e.g., wiring, for generating bits s₁ . . . s_{c} based on the value s of signal 166. Generator 146 may additionally or alternatively include any suitable configuration for generating signals 164 based on signals 166.

According to some demonstrative embodiments of the invention, the number of cycles j performed by dividing unit 144 may be determined based on any desired criteria, e.g., corresponding to the convergence of the division of P by D. The number of cycles j may be related, for example, to the radix of dividing unit 144 and/or the radix of divider 142. For example, dividing unit 144 may perform j=2 cycles, e.g., if the radix of dividing unit 144 is sixteen, the number k of quotient bits determined in the preprocessing stage is two, and the radix of divider 142 is 256.

According to some demonstrative embodiments of the invention, generator 160 may receive, e.g., from dividing unit 144, signals 158 corresponding to one or more quotient digits q′ₘ₊₁ of cycles m′=0 . . . j−1, e.g., j quotient digits of the division operation corresponding to the divisor D and the number one. Generator 160 may generate signals 162 corresponding to the value gP based on the quotient digits q′ₘ₊₁, e.g., as described below. According to other embodiments, generator 160 may implement any other suitable method to generate signals 162, e.g., as is known in the art.

According to some demonstrative embodiments of the invention, the value gP may be determined according to the following equation, which may be derived for example, from Equation 20:

$$gP = \frac{{( {r}^{′} )}^{1 - j}}{{r}_{0}} {Q}_{j}^{′} P \qquad ( 25 )$$

According to some demonstrative embodiments of the invention, the value Q′ⱼ may be determined, for example, by performing j calculation cycles for summing the values of quotient digits corresponding to the j cycles. A cumulative value Pₗ₊₁ of a division cycle l+1, l=1 . . . j−1, may be determined, for example, using the following recursive equations:
P₀=0 (26)
P₁=r₀P₀+q′ₗ₊₁P (27)
Pₗ₊₁=rP₁+q′ₗ₊₁P (28)

According to some demonstrative embodiments of the invention, one or more of the cumulative values Pₗ₊₁ may be determined in parallel to one or more respective division cycles performed by dividing unit 144.

According to some exemplary embodiments of the invention, the value Q′ⱼ may be determined after j cycles, e.g., in accordance with the following equation, which may be derived by induction from Equations 26-28:
Q′ⱼP=Pⱼ (29)

Thus, according to some demonstrative embodiments of the invention, the value gP may be determined in accordance with the following equation, which may be derived by substituting Equation 29 in Equation 25:

$$gP = \frac{{( {r}^{′} )}^{1 - j}}{{r}_{0}} {P}_{j} \qquad ( 30 )$$

According to some demonstrative embodiments of the invention, generator 160 may include any suitable configuration, e.g., hardware configuration, for generating signals 162, e.g., in accordance with Equation 30. For example, generator 160 may include a first configuration for generating signals corresponding to the value Pⱼ; and a second configuration for generating signals 162 by applying to the signals corresponding to the value Pⱼ a transformation based on Equation 30.

According to some demonstrative embodiments of the invention, generator 160 may be implemented using one or more elements of main loop 149, e.g., as described below. However, it will be appreciated by those skilled in the art that according to other embodiments, generator 160 may be implemented by any other suitable configuration, e.g., separate from or combined with divider 142.

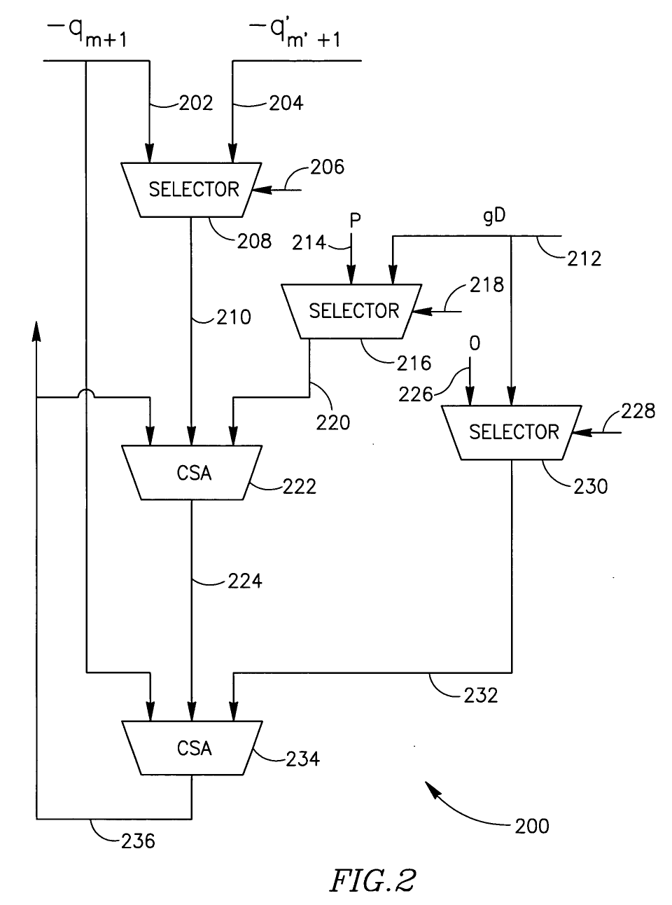

Reference is made to FIG. 2, which schematically illustrates a dividend value generator configuration 200 in accordance with some demonstrative embodiments of the invention.

Although the invention is not limited in this respect, configuration 200 may be implemented by arrangement 120 (FIG. 1), e.g., for determining the value P.

According to some demonstrative embodiments of the invention, configuration 200 may include first, second and third selectors 208, 216, and 230, respectively. Selectors 208, 216 and/or 230 may include any selector, e.g., a 2:1 multiplexer as is known in the art, for selectively providing an output signal corresponding to either one of two input signals.

Selector 208 may receive a signal 204 corresponding to the quotient digit q′_{m′+1}, e.g., from dividing unit 144 (FIG. 1); and/or a signal 202 corresponding to the value −(qₘ₊₁), e.g., from divider 142 (FIG. 1). Selector 208 may selectively provide a signal 210 corresponding to either signal 202 or signal 204, e.g., based on a control signal 206.

Selector 216 may receive a signal 214 corresponding to the value P, and/or a signal 212 corresponding to the value gD, e.g., from dividing unit 144 (FIG. 1). Selector 216 may selectively provide a signal 220 corresponding to either signal 214 or signal 212, e.g., based on a control signal 218.

Selector 230 may receive signal 212, and/or a signal 226 corresponding to the value zero. Selector 230 may selectively provide a signal 232 corresponding to either signal 212 or signal 226, e.g., based on a control signal 228.

Configuration 200 may also include first and second summation arrangements, e.g., a first CSA arrangement 222 and a second CSA arrangement 234. CSA arrangement 222 may generate a signal 224 having a value corresponding to a sum of the values of signals 210, 220 and a signal 236 received from CSA arrangement 234. For example, CSA arrangement 222 may generate signal 224 according to the following equation:
S₂₂₄=r*S₂₃₆+S₂₁₀*S₂₂₀ (31)
wherein S₂₂₄, S₂₃₆, S₂₁₀, and S₂₂₀ denote the values of signals 224, 236, 210, and 220, respectively.

CSA arrangement 234 may generate signal 236 having a value corresponding to the sum of the values of signals 224, 202 and 232. For example, CSA arrangement 234 may generate signal 236 according to any suitable calculation method implemented by divider 142 (FIG. 1). In some demonstrative embodiments of the invention, CSA 234 may be adapted to generate signal 236 having the same value as signal 224, e.g., if selector 230 generates signals 232 corresponding to the value zero, e.g., as described below.

According to some demonstrative embodiments of the invention, CSA arrangements 222 and/or 234 may be implemented for performing the functionality of main loop 149 (FIG. 1), e.g., for determining Rₘ₊₁; and/or the functionality of gP generator 160 (FIG. 1), e.g., for determining Pⱼ, as described below.

According to one demonstrative embodiment of the invention, selector 208 may be controlled, e.g., using signal 206, to provide CSA 222 with signal 210 corresponding to the quotient digit q′_{m′+1}; selector 216 may be controlled, e.g., using signal 218, to provide CSA 222 with signal 220 corresponding to the dividend P, e.g., of signal 214; and selector 230 may be controlled e.g., using signal 228, to provide CSA 234 with signal 232 corresponding to the value zero. CSA arrangement 222 may be controlled, e.g., using signal 293, to generate signal 224 according to Equation 31. Accordingly, signal 224 may have a value corresponding to the value of Pₗ₊₁, e.g., after l division cycles, for example, in accordance with Equation 28. Accordingly, signal 224 may have a value corresponding to the value Pⱼ, e.g., after j division cycles.

According to another demonstrative embodiment of the invention, selector 208 may be controlled, e.g., by signal 206, to provide CSA 222 with signal 210 corresponding to the value −(qₘ₊₁); selector 216 may be controlled, e.g., by signal 218, to provide CSA 222 with signal 220 corresponding to the value gD, e.g., of signal 212; and selector 230 may be controlled, e.g., by signal 228, to provide CSA 234 with signal 232 corresponding to the value gD. CSA arrangement 222 may be controlled, e.g., by signal 293, to generate signal 224 according to Equation 32. Accordingly, signal 224 may have a value corresponding to the value of Rₘ₊₁, e.g., after m division cycles, for example, in accordance with Equation 2.

Following are examples for determining the value gD using a dividing unit of a first radix; and dividing the number P by the number D, by dividing the value gP by the value gD, e.g., using a second divider of a second radix. It should be noted that these examples have been randomly selected for demonstrative purposes only and are not intended to limit the scope of the invention to any particular choice of the first and second dividers.

According to one demonstrative embodiment of the invention, the first divider may have a radix r′=16, and the second divider may have a radix r=256. The first divider may be used to perform j=3 division cycles, e.g., including the preprocessing stage, which may have a radix r₀=4. The remainder R′_{m′} of the first divider may satisfy the following condition:

$$\vert {R}_{{m}^{′}}^{′} \vert < \frac{D}{2} + \frac{1}{30} \qquad ( 32 )$$

Substituting Condition 32 in Equation 21 may yield the following:

$$gD = 1 - \frac{{( {r}^{′} )}^{1 - 3}}{{r}_{0}} {R}_{3}^{′} ⇒ \vert 1 - gD \vert < {2}^{- 10} ( \frac{D}{2} + \frac{1}{30} ) \qquad ( 33 )$$

Thus, the values of gD, q₁, and/or gP may be determined, for example, after three cycles.

Since the second divider has a radix of 256, each division cycle of the second divider may generate 8 bits of the quotient Q corresponding to the division of the number P by the number D. Accordingly, 64 bits of the quotient Q may be determined, for example, after performing eight division cycles of the second divider. An additional number of post-processing cycles, e.g., two cycles, may be performed for generating a 67-bit quotient.

According to another demonstrative embodiment of the invention, the first divider may have a radix r′=8, and the second divider may have a radix r=256. The first divider may be used to perform j=5 division cycles, e.g., including the preprocessing stage, which may have a radix r₀=1. The remainder R′_{m′} of the first divider may satisfy the following condition:
|R′_{m′}|≦D (34)

Substituting Condition 34 in Equation 21 may yield the following:

$$gD = 1 - \frac{{( {r}^{′} )}^{1 - 5}}{{r}_{0}} {R}_{5}^{′} ⇒ \vert 1 - gD \vert < {2}^{- 12} D \qquad ( 35 )$$

Thus, the values of gD, q₁, and/or gP may be determined, for example, after five cycles.

Since the second divider has a radix of 256, each division cycle of the second divider may generate 8 bits of the quotient Q corresponding to the division of the number P by the number D. Accordingly, 64 bits of the quotient Q may be determined, for example, after performing eight division cycles of the second divider. An additional number of post-processing cycles, e.g., two cycles, may be performed for generating a 67-bit quotient.

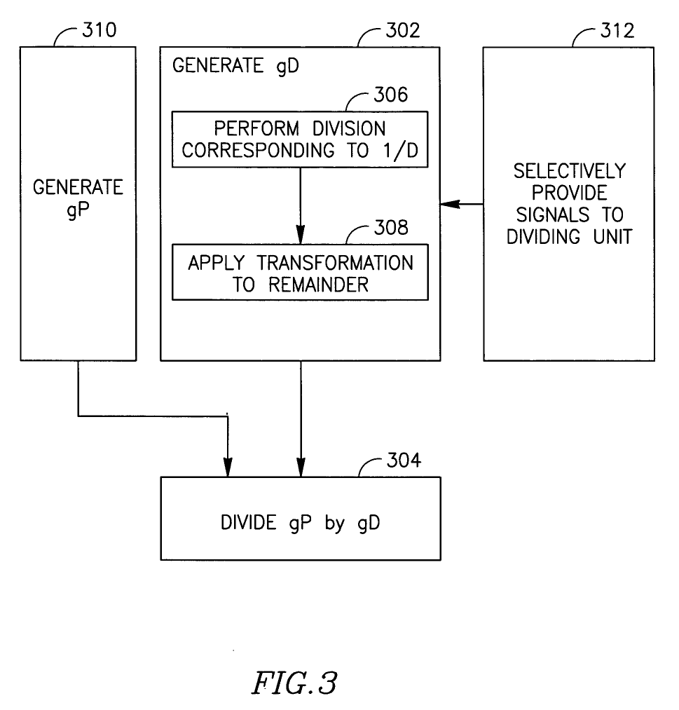

Reference is made to FIG. 3, which schematically illustrates a method of dividing a first number by a second number in accordance with some demonstrative embodiments of the invention.

As indicated at block 302, the method may include generating the value gD corresponding to the remainder of a division of the number one by the second number. Generating the value gD may include, for example, using a divisor value generator generator, e.g., generator 140 as described above with reference to FIG. 1.

As indicated at block 306, generating the value gD may include performing a division operation including a predetermined number of division cycles corresponding to the division of the number one by the second number. Performing the division operation may include, for example, using a dividing unit, e.g., dividing unit 144 as described above with reference to FIG. 1.

As indicated at block 308, generating the value gD may also include applying a tansformation to a remainder of the division operation. The transformation may be based, for example, on the predetermined number of division cycles and a radix of the division operation, e.g., as described above. Applying the transformation to the remainder of the division operation may include, for example, using a transformation module, e.g., transformation module 146 as described above with reference to FIG. 1.

As indicated at block 310, the method may also include generating the value gP based on the first number and one or more quotient digits corresponding to one or more of the division cycles, respectively. Generating the value gP may include, for example, using a dividend value generator, e.g., generator 160 as described above with reference to FIG. 1.

As indicated at block 304, the method may also include dividing the value gP by the value gD. Dividing the value gP by the value gD may include, for example, using a divider, e.g., divider 142 as described above with reference to FIG. 1. For example, the method may include performing a division operation having a radix of at least four.

As indicated at block 312, the method may also include, for example, selectively providing signals corresponding to the second number and the number one to first and second inputs of the dividing unit, respectively. The method may also include performing a predetermined operation on a third number by selectively providing a signal corresponding to the third number to one of the dividing unit inputs. Selectively providing the signals to the dividing unit inputs may include, for example, using a selector, e.g., selector 179 as described above with reference to FIG. 1.

Reference is made to FIG. 4, which schematically illustrates a divider 400 in accordance with some demonstrative embodiments of the invention.

Although the invention is not limited in this respect, divider 400 may perform the functionality of divider 142 (FIG. 1).

According to some demonstrative embodiments of the invention, divider 400 may include a main loop 402. Although the invention is not limited in this respect, main loop 402 may perform the functionality of main loop 149 (FIG. 1). Main loop 402 may include an encoded-remainder generator 406 to generate a plurality of signals having values corresponding to sum (s) and carry (c) bits of a redundant form of an encoded remainder value, denoted Rₘ₊₁^{encoded}. The encoded remainder value may be determined, for example, according to the following equation:
Rₘ₊₁^{encoded}=Rₘ₊₁+γ (36)
wherein γ denotes an encoding constant which may be determined, e.g., based on desired criteria as described below.

Generator 406 may include, for example, an adder arrangement 406 to generate the encoded remainder value Rₘ₊₁^{encoded} by adding encoding constant γ to the remainder value Rₘ₊₁. For example, generator 406 may include a 8:2 CSA, e.g., including three 4:2 CSAs 416, 418 and 420, to receive a plurality of signals, e.g., signals 422, 424, 426, 428, 430, 432 and 434, corresponding to the remainder Rₘ₊₁; and a signal 436 having a value corresponding to the value γ. For example, signals 422 and 424 may correspond to carry and save values of a product of the partial remainder R′ₘ; and the radix r′; and/or signals 426, 428, 430, 432 and/or 434 may correspond to a product of the value gD and the quotient digit q′_{m′+}1. Signals 422, 424, 426, 428, 430, 432, and/or 434 may be generated, for example, by any suitable element of divider 400, e.g., as known in the art.

According to some demonstrative embodiments of the invention, signals 426, 428, 430, 432 and/or 434 may be generated based on a plurality of quotient-digit coefficients denoted, a₀, a₁, a₂, a₃, . . . a_{ρ/2}, corresponding to the quotient digit qₘ₊₁ For example, main loop 402 may generate signals 426, 428, 430, 432 and/or 434 based on a plurality of signals corresponding to quotient-digit coefficients a₀, a₁, a₂, a₃, . . . a_{ρ/2}. The signals corresponding to quotient-digit coefficients a₀, a₁, a₂, a₃, . . . a_{ρ/2}, may be generated, for example, by selector 404, e.g., as described in detail below. Main loop 402 may include any suitable configuration for generating signals 426, 428, 430, 432 and/or 434, e.g., according to the following Equation:

$${q}_{m + 1} D = {\sum }_{j = 0}^{\frac{ρ}{2}} {a}_{j} {2}^{ρ - 2 j} D \qquad ( 37 )$$

Generator 406 may generate, e.g., based on signals 422, 424, 426, 428, 430, 432, 434 and/or 436, a plurality of signals, e.g., signals 440, corresponding to sum bits of encoded remainder value Rₘ₊₁^{encoded}; and plurality of signals, e.g., signals 438, corresponding to carry bits of encoded remainder value Rₘ₊₁^{encoded}. According to other embodiments of the invention, generator 406 may include any other suitable configuration, e.g., including one or more CSAS, to generate signals 438 and/or 440.

According to some demonstrative embodiments of the invention, divider 400 may also include a quotient digit selector 404 to generate a plurality of independent interim values by adding at least first and second sets of one or more carry bits of encoded remainder value Rₘ₊₁^{encoded} to at least first and second sets of one or more sum bits of encoded remainder value Rₘ₊₁^{encoded}, respectively; and to generate a plurality of coefficients corresponding to quotient digit qₘ₊₁ based on the plurality of interim values, as described below.

According to some demonstrative examples of the invention, selector 404 may generate two or more of the interim values in parallel, e.g., as described below.

According to some demonstrative embodiments of the invention, the sum and carry bits of the redundant form of encoded remainder value Rₘ₊₁^{encoded} may be represented in the following binary representations:
s=α₁α₀.α−₁α₋₂α₋₃ . . . α_{-ρ/2} (38)
c=β₁β₀.β−₁β₋₂β₋₃ . . . β_{-ρ/2} (39)

According to some demonstrative embodiments of the invention, selector 404 may include an adder configuration 409, e.g., including at least first and second adders, to independently add the at least first and second sets of carry bits to the at least first and second sets of sum bits, respectively, as described below.

According to some demonstrative examples of the invention, adder configuration 409 may add, in parallel, the sets of carry bits to the sets of sum bits, respectively.

According to some demonstrative embodiments of the invention, the sets of carry bits may include sets of two carry bits of encoded remainder Rₘ₊₁^{encoded}; and the sets of sum bits may include sets of two bits of the encoded remainder Rₘ₊₁^{encoded}. The sets of two sum bits may be independently added to the sets of carry bits of the encoded remainder Rₘ₊₁^{encoded}, e.g., as follows:

$$\begin{matrix}{α}_{1} {α}_{0} + \\ {β}_{1} {β}_{0} = \\ {σ}_{1} {σ}_{0}\end{matrix} \vert \begin{matrix}{α}_{- 1} {α}_{- 1} + \\ {β}_{- 1} {β}_{- 2} = \\ {c}_{- 1} {σ}_{- 1} {σ}_{- 2}\end{matrix} \vert Λ \vert \begin{matrix}{α}_{1 - \frac{ρ}{2}} {α}_{- \frac{ρ}{2}} + \\ {β}_{1 - \frac{ρ}{2}} {β}_{- \frac{ρ}{2}} = \\ {c}_{1 - \frac{ρ}{2}} {σ}_{1 - \frac{ρ}{2}} {σ}_{- \frac{ρ}{2}}\end{matrix} \vert \begin{matrix}{α}_{- \frac{ρ}{2} - 1} {α}_{- \frac{ρ}{2} - 2} + \\ {β}_{- \frac{ρ}{2} - 1} {β}_{- \frac{ρ}{2} - 2} = \\ {c}_{- \frac{ρ}{2} - 1} {σ}_{- \frac{ρ}{2} - 1} {σ}_{- \frac{ρ}{2} - 2}\end{matrix} Λ \qquad ( 40 )$$

wherein σ_{-2g+1} and σ_{-2g} denote first and second interim sum values corresponding to the sum of the g-th set of sum bits, denoted α_{-2g+1}α_{-2g}, and the g-th set of carry bits, denoted β_{-2g+1}β_{-2g}, respectively; and wherein c_{-2g+1} denotes an interim carry value corresponding to the sum of α_{2g+1}α₋₂ and β_{-2g+1}β_{-2g}.

According to some demonstrative embodiments of the invention, the number of signals 438 and/or 440, e.g., which may be used for determining the quotient-digit coefficients, may correspond, for example, to the radix of divider 400. Accordingly, adder configuration 409 may include a number of adders corresponding to the radix of divider 400. For example, signals 440 may include twelve signals corresponding to twelve sum bits of encoded remainder value Rₘ₊₁^{encoded}; and signals 438 may include twelve signals corresponding to twelve carry bits of encoded remainder value Rₘ₊₁^{encoded}, e.g., if divider 400 has a radix of 256. Accordingly, adder configuration 409 may include six adders, e.g., including adders 412 and 414, to add six sets of two sum bits to six sets of two carry bits, respectively.

For example, signals 440 may include twelve signals including signals 442, 444, 450 and 452, e.g., corresponding to the values α₁, α₀, α_{--ρ/2}, and α_{-2-ρ/2}, respectively; and signals 438 may include twelve signals including signals 446, 448, 454 and 456, e.g., corresponding to the values β₁, β₀, β_{-1-ρ/2}, and β_{-2-ρ/2}, respectively. Adder 412 may receive signals 442, 444, 446 and 448; and generate signal 458, e.g., corresponding to the interim value c₀; and signals 460 corresponding to the interim values σ₁, and σ₀. Adder 414 may receive signals 450, 452, 454 and 456; and generate signal 462, e.g., corresponding to the interim value c_{-1-ρ/2}; and signals 460 corresponding to the interim values σ_{-1-ρ/2}, and σ_{-2-ρ/2}.

According to some demonstrative embodiments of the invention, selector 404 may also include a quotient-digit coefficient generator 410 to generate a plurality of quotient-digit coefficient signals corresponding to the plurality of coefficients a₀, a₁, a₂, a₃, . . . a_{ρ}, based on the interim values received from adder configuration 409. For example, generator 410 may generate signals 466, 468, and 470 corresponding to coefficients a₀, a₁ and a_{ρ}, respectively. For example, generator 410 may generate the plurality of quotient-digit coefficient signals, according to the following equations:
α₀=c₋₁+σ₀+2(σ₁−1)
αᵢ=c₋₂ᵢ₋₁+σ₋₂ᵢ+2(σ₋₂ᵢ₊₁−1) (41)
wherein i=1, 2, . . . ρ.

According to some demonstrative embodiments of the invention, selector 404 may also include a quotient digit generator 408 to generate signals 472 corresponding to quotient digit qₘ₊₁ by combining the plurality of quotient digit coefficients. For example, generator 408 may generate signals 472 according to the following equation:

$${q}_{m + 1} D = {\sum }_{j = 0}^{\frac{ρ}{2}} {a}_{j} {2}^{ρ - 2 j} \qquad ( 42 )$$

Generator 408 may include any desired quotient bit generator configuration, e.g., as is known in the art.

According to some demonstrative embodiments of the invention, the encoded remainder value Rₘ₊₁^{encoded} may be determined, for example, using the following equation, which may be derived from Equation system 40:

$$\begin{matrix}{R}_{m + 1}^{encoded} = {R}_{m + 1} + γ \\ = 2 {σ}_{1} + {σ}_{0} + {\sum }_{j = 1}^{N} ( 4 {c}_{1 - 2 j} + 2 {σ}_{1 - 2 j} + {σ}_{- 2 j} ) {2}^{- 2 j} \\ = {\sum }_{j = 0}^{N} ( 2 {σ}_{1 - 2 j} + {σ}_{- 2 j} + {c}_{- 2 j - 1} ) {2}^{- 2 j}\end{matrix} \qquad ( 43 )$$

According to some demonstrative embodiments of the invention, the encoding constant γ may be determined as follows:

$$γ = {\sum }_{j = 0}^{N} {2}^{1 - 2 j} = 010.1010 K 10101 \qquad ( 44 )$$

wherein N is a predetermined integer number, corresponding to half of a data path width if the division operation. For example, N may equal 40.

According to some demonstrative embodiments of the invention, the following equation may be derived by substituting Equation 44 in Equation 43:

$${R}_{m + 1} = {R}_{m + 1}^{encoded} - γ = {\sum }_{j = 0}^{N} ( 2 {σ}_{1 - 2 j} + {σ}_{- 2 j} + {c}_{- 2 j - 1} ) {2}^{- 2 j} - {\sum }_{j = 0}^{N} {2}^{1 - 2 j} \qquad ( 45 )$$

Equation 45 may be re-arranged as follows:

$${R}_{m + 1} ⩵ {\sum }_{j = 0}^{N} ( 2 {σ}_{1 - 2 j} + {σ}_{- 2 j} + {c}_{- 2 j - 1} - 2 ) {2}^{- 2 j} \qquad ( 46 )$$

According to some demonstrative embodiments of the invention, Equations 41, 42 and 46 may be combined into the following equation:

$$\vert {2}^{ρ} {R}_{m + 1} - {q}_{m + 1} \vert = {\sum }_{j = \frac{ρ}{2} + 1}^{N} ( 2 {σ}_{1 - 2 j} + {σ}_{- 2 j} + {c}_{- 2 j - 1} - 2 ) {2}^{- 2 j} \qquad ( 47 )$$

Since the expression 2σ₁₋₂ⱼ+σ₋₂ⱼ+c₋₂ⱼ₋₁ may have a value of either −2, −1, 0, 1, or 2, Equation 47 may be estimated as follows, e.g., using the formula of geometric progression:

$$\vert {2}^{ρ} {R}_{m + 1} - {q}_{m + 1} \vert = {\sum }_{j = \frac{ρ}{2} + 1}^{N} {2}^{ρ - 2 j} = 2 \frac{\frac{1}{4}}{1 - \frac{1}{4}} = \frac{2}{3} \qquad ( 48 )$$

Thus, it will be appreciated by those skilled in the art that the division operation performed by divider 400 may converge relatively efficiently, e.g., if the quotient digit qₘ₊₁ is generated in accordance with Equation 42.

It will be appreciated by those skilled in the art that a divider according to some demonstrative embodiments of the invention, e.g., divider 400, may generate a high radix quotient digit, e.g., a 256-bit quotient digit or a quotient digit of any other desired number of bits, during a single division cycle.

Some demonstrative embodiments of the invention are described above in relation to an encoding constant determined in accordance with an adder configuration e.g., configuration 401, to independently add at least first and second sets of two carry bits of the encoded remainder value Rₘ₊₁^{encoded} to at least first and second sets of two sum bits of the encoded remainder value Rₘ₊₁^{encoded}, respectively. However, it will be appreciated by those skilled in the art that in other embodiments of the invention the encoding constant may be determined in accordance with an adder configuration able to independently add at least first and second sets of any desired number of carry and sum bits of the encoded remainder value Rₘ₊₁^{encoded}. For example, the encoding constant may be determined as follows, e.g., if the quotient digit qₘ₊₁ is to be generated using an adder configuration to independently add at least first and second sets of three carry bits of the encoded remainder value Rₘ₊₁^{encoded} to at least first and second sets of three sum bits of the encoded remainder value Rₘ₊₁^{encoded}, respectively:

$$γ = {\sum }_{j = 0}^{N} {s}^{2 - 3 j} = 0100.1001001 K 1001001… \qquad ( 49 )$$

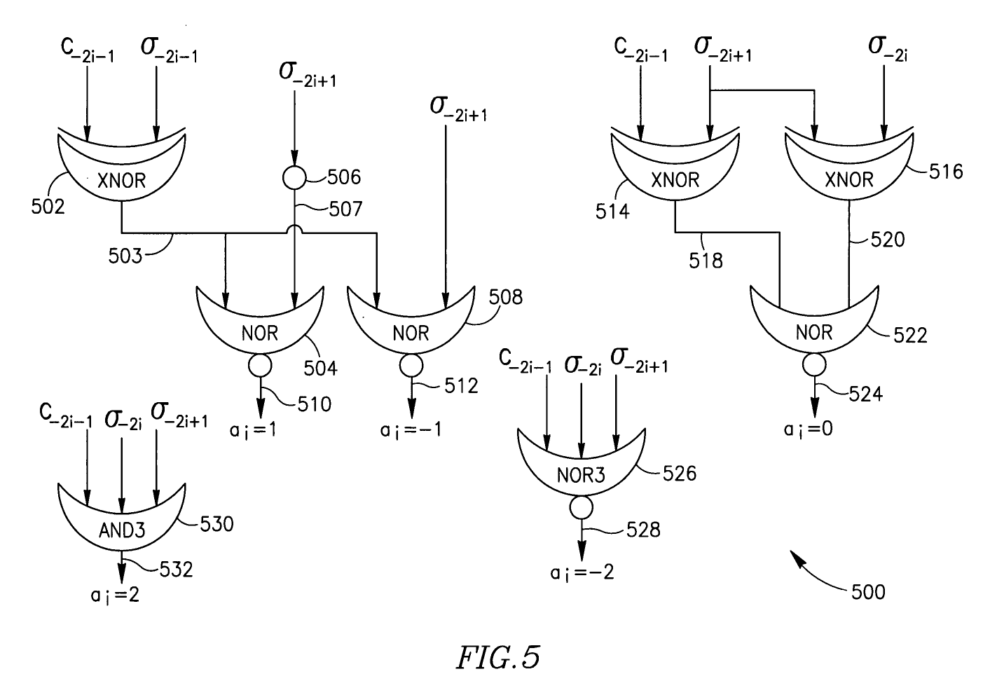

Reference is made to FIG. 5, which schematically illustrates a quotient-digit coefficient generator 500 in accordance with some demonstrative embodiments of the invention.

Although the invention is not limited in this respect, generator 500 may perform the functionality of quotient-digit coefficient generator 410 (FIG. 4).

According to some demonstrative embodiments of the invention, generator 500 may generate the plurality of coefficients a₀, a₁, a₂, a₃, . . . , a_{ρ/2}, e.g., in accordance with Equation set 41, as described below.

According to Equation set 41, coefficient αᵢ may have a value of (−2), e.g., if c₋₂ᵢ₋₁=0, σ₋₂ᵢ=0, and σ₋₂ᵢ₊₁=0. Coefficient αᵢ may have a value of (−1), e.g., if c₋₂ᵢ₋₁=0, σ₋₂ᵢ=1, and σ₋₂ᵢ₊₁=0; or if c₋₂ᵢ₋₁=1, σ₋₂ᵢ=0, and σ₋₂ᵢ₊₁=0. Coefficient αᵢ may have a zero value, e.g., if c₋₂ᵢ₋₁=0, σ₋₂ᵢ=0, and σ₋₂ᵢ₊₁=1; or if c₋₂ᵢ₋₁=1, σ₋₂ᵢ=1, and σ₋₂ᵢ₊₁=0. Coefficient αᵢ may have a value of 1, e.g., if c₋₂ᵢ₋₁=0, σ₋₂ᵢ=1, and σ₋₂ᵢ₊₁=1; or if c₋₂ᵢ₋₁=1, σ₋₂ᵢ=0, and σ₋₂ᵢ₊₁=1. Coefficient αᵢ may have a value of 2, e.g., if c₋₂ᵢ₋₁=1, σ₋₂ᵢ=1, and σ₋₂ᵢ₊₁=1.

According to some demonstrative embodiments of the invention, generator 500 may include a configuration of logical gates to generate one or more of the quotient-digit coefficients, for example, based on one or more of the values c₋₂ᵢ₋₁, σ₋₂ᵢ, and σ₋₂ᵢ₊₁, e.g., as received from adder configuration 409 (FIG. 4).

Generator 500 may include, for example, an XNOR gate 502 to generate a signal 503 corresponding to a logical XNOR operation performed on the values c₋₂ᵢ₋₁, and σ₋₂ᵢ; a NOT gate 506 to generate a signal 507 corresponding to a logical NOT operation performed on the value σ₋₂ᵢ₊₁; a NOR gate 504 to generate a signal 510 corresponding to a logical NOR operation performed on the values of signals 507 and 503; and a NOR gate 508 to generate a signal 512 corresponding to a logical NOR operation performed on the value of signal 503 and the value σ₋₂ᵢ₊₁.

Generator 500 may also include, for example, an XNOR gate 514 to generate a signal 518 corresponding to a logical XNOR operation performed on the values c₋₂ᵢ₋₁, and σ₋₂ᵢ₊₁; an XNOR gate 516 to generate a signal 520 corresponding to a logical XNOR operation performed on the values σ₋₂ᵢ and σ₋₂ᵢ₊₁; and a NOR gate 522 to generate a signal 524 corresponding to a logical NOR operation performed on the values of signals 518 and 520.

Generator 500 may also include, for example, an AND3 gate 530 to generate a signal 532 corresponding to a logical AND operation performed on the values c₋₂ᵢ₋₁, σ₋₂ᵢ, and σ₋₂ᵢ₊₁.

Generator 500 may also include, for example, a NOR gate 526 to generate a signal 528 corresponding to a logical NOR operation performed on the values c₋₂ᵢ₋₁, σ₋₂ᵢ, and σ₋₂ᵢ₊₁.

According to some demonstrative embodiments of the invention, the coefficient αᵢ may be generated based on the values of signals 510, 512, 524, 532, and/or 528. For example, the coefficient aᵢ may have a value of (−2), e.g., if the value of signal 528 is one; a value of (−1), e.g., if the value of signal 512 is one; a zero value, e.g., if the value of signal 524 is one; a value of 1, e.g., if the value of signal 510 is one; or a value of 2, e.g., if the value of signal 532 is one.

It will be appreciated by those skilled in the art that the above configuration of logical gates is only for demonstrative purposes, and that according to other embodiments of the invention, generator 500 may include any other suitable configuration for generating one or more of the quotient-digit coefficients.

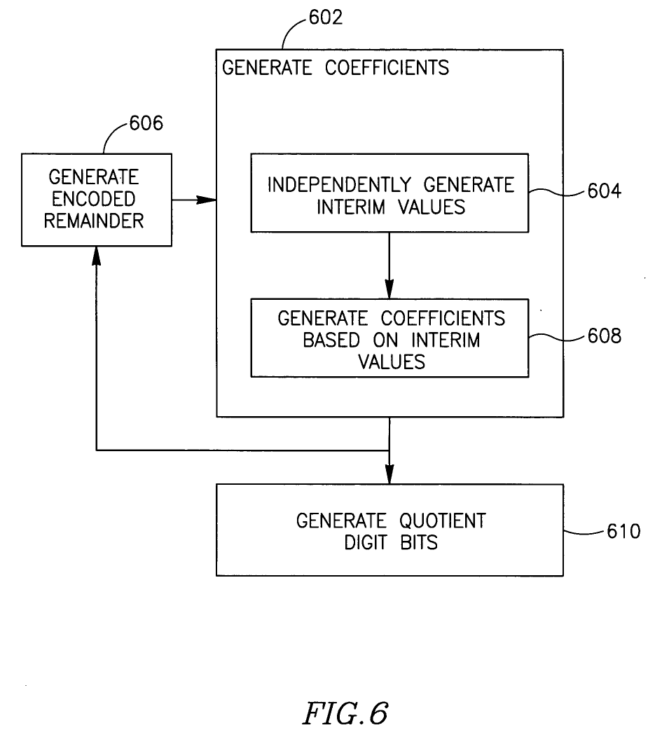

FIG. 6 is a schematic block diagram illustration of a method of generating a quotient digit corresponding to a cycle of a division operation in accordance with some demonstrative embodiments of the invention.

As indicated at block 602, the method may include generating a plurality of quotient-digit coefficients corresponding to the quotient digit qₘ₊₁. Generating the plurality of quotient-digit coefficients may include, for example, using a quotient digit selector, e.g., selector 404 as described above with reference to FIG. 4.

As indicated at block 604, generating the plurality of quotient-digit coefficients may include generating a plurality of independent interim values by adding at least first and second sets of one or more carry bits of an encoded remainder value corresponding to the division cycle, to at least first and second sets of one or more sum bits of the encoded remainder value, respectively. For example, generating the plurality of interim values may include generating the plurality of interim values by independently adding at least first and second sets of two carry bits of the encoded remainder value to at least first and second sets of two sum bits of the encoded remainder value, respectively. Independently generating the plurality of interim values may include, for example, using an adder configuration, e.g., adder configuration 409 as described above with reference to FIG. 4.

As indicated at block 608, generating the plurality of quotient-digit coefficients may also include generating the plurality of quotient-digit coefficients based on the plurality of interim values. Generating the plurality of quotient-digit coefficients based on the plurality of interim values may include, for example, using quotient-digit coefficient generator, e.g., generator 410 as described above with reference to FIG. 4.

As indicated at block 610, the method may include generating one or more bits corresponding to the quotient digit by combining two or more of the plurality of quotient-digit coefficients. Generating the one or more bits corresponding to the quotient digit may include, for example, using a quotient digit generator, e.g., generator 408 as described above with reference to FIG. 4.

As indicated at block 606, the method may include generating the encoded remainder value by adding a predetermined encoding constant value to a remainder value corresponding to the division cycle. The encoding constant value may be based, for example, on the number of bits in one or more of the sets of one or more carry bits. The remainder value corresponding to the division cycle may be generated, for example, based on one or more of the quotient-digit coefficients. Generating the encoded remainder value may include, for example, using an encoded-remainder generator, e.g., generator 406 as described above with reference to FIG. 4.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A method comprising:
generating a first value relating to a first number;
generating a second value corresponding to a remainder of a division of the number one by a second number; and
dividing said first value by said second value.

2. The method of claim 1, wherein generating said first value comprises generating said first value representing a product of said first number and an approximate reciprocal of said second number, and wherein generating said second value comprises generating said second value representing a product of said second number and the approximate reciprocal of said second number.

3. The method of claim 1, wherein generating said second value comprises:
performing a division operation including a predetermined number of division cycles corresponding to the division of the number one by said second number; and
generating said second value by applying a transformation to a remainder of said division operation.

4. The method of claim 3, wherein generating said first value comprises generating said first value based on said first number and one or more quotient digits corresponding to one or more of said division cycles, respectively.

5. The method of claim 3, wherein applying said transformation comprises applying said transformation, which is based on said predetermined number of division cycles and a radix of said division operation.

6. The method of claim 3, wherein performing said division operation comprises selectively providing signals corresponding to said second number and the number one to first and second inputs of a dividing unit, respectively, and wherein said method comprises performing a predetermined operation on a third number by selectively providing a signal corresponding to said third number to one of said inputs.

7. The method of claim 1, wherein dividing said first value by said second value comprises performing a division operation having a radix of at least four.

8. An apparatus comprising:
a dividend value generator to generate a first value relating to a first number;
a divisor value generator to generate a second value corresponding to a remainder of a division of the number one by a second number;
a divider to divide said first value by said second value.

9. The apparatus of claim 8, wherein said first value represents a product of said first number and an approximate reciprocal of said second number, and wherein said second value represents a product of said second number and the approximate reciprocal of said second number.

10. The apparatus of claim 8, wherein said divisor value generator comprises:
a dividing unit to perform a division operation including a predetermined number of division cycles corresponding to the division of the number one by said second number; and
a transformation module to generate said second value by applying a transformation to a remainder of said division operation.

11. The apparatus of claim 10, wherein said dividend value generator is able to generate said first value based on said first number and one or more quotient digits of one or more of said division cycles, respectively.

12. The apparatus of claim 10, wherein said transformation is based on said predetermined number of division cycles and a radix of said division operation.

13. The apparatus of claim 10 comprising a selector to selectively provide signals corresponding to said second number and the number one to first and second inputs of said dividing unit, respectively.

14. The apparatus of claim 8, wherein said divider comprises a divider having a radix of at least four.

15. A system comprising:
a processor including:
a dividend value generator to generate a first value relating to a first number;
a divisor value generator to generate a second value corresponding to a remainder of a division of the number one by a second number; and
a divider to divide said first value by said second value; and
a memory associated with said processor and able to store one or more values corresponding to the division of said first number by said second number.

16. The system of claim 15, wherein said divisor value generator comprises:
a dividing unit to perform a division operation including a predetermined number of division cycles corresponding to the division of the number one by said second number; and
a transformation module to generate said second value by applying a transformation to a remainder of said division operation.

17. The system of claim 16, wherein said transformation is based on said predetermined number of division cycles and a radix of said division operation.

18. A method comprising:
generating a plurality of independent interim values by adding at least first and second sets of one or more carry bits of an encoded remainder value corresponding to a cycle of a division operation to at least first and second sets of one or more sum bits of said encoded remainder value, respectively; and
generating a plurality of coefficients corresponding to a quotient digit of said cycle based on said plurality of interim values.

19. The method of claim 18, wherein generating said plurality of interim values comprises generating said plurality of interim values by adding at least first and second sets of two carry bits of said encoded remainder value to at least first and second sets of two sum bits of said encoded remainder value, respectively.

20. The method of claim 18 comprising generating said encoded remainder value by adding a predetermined encoding constant value to a remainder value corresponding to said cycle.

21. The method of claim 20, wherein adding said predetermined encoding constant value comprises adding said encoding constant value, which is based on the number of bits in one or more of said sets of one or more carry bits.

22. The method of claim 21, wherein adding said predetermined encoding constant value comprises adding the value
$${\sum }_{j = 0}^{N} {2}^{1 - 2 j}$$
to the remainder of said cycle, wherein N is a predetermined integer.

23. The method of claim 20 comprising determining the remainder value corresponding to said cycle based on one or more of said interim values.

24. The method of claim 18 comprising generating one or more quotient digit bits corresponding to said quotient digit by combining one or more of said plurality of coefficients.

25. The method of claim 24, wherein generating said one or more quotient digit bits comprises generating at least two quotient digit bits in said division operation cycle.

26. An apparatus comprising:
a quotient digit selector to generate a plurality of independent interim values by adding at least first and second sets of one or more carry bits of an encoded remainder value corresponding to a cycle of a division operation to at least first and second sets of one or more sum bits of said encoded remainder value, respectively; and to generate a plurality of coefficients corresponding to a quotient digit of said cycle based on said plurality of interim values.

27. The apparatus of claim 26, wherein said quotient digit selector comprises a quotient bit generator to generate one or more quotient digit bits corresponding to said quotient digit based on a combination of one or more of said plurality of coefficients.

28. The apparatus of claim 26, wherein said quotient digit selector comprises at least first and second adders for generating said plurality of interim values by adding said at least first and second sets of carry bits to said at least first and second sets of sum bits, respectively.

29. The apparatus of claim 28, wherein said at least first and second adders comprise at least six adders for generating at least six interim values by adding at least six sets of two carry bits to at least six sets of two sum bits, respectively.

30. The apparatus of claim 26 comprising an adder arrangement to generate said encoded remainder value by adding a predetermined encoding constant value to a remainder value corresponding to said cycle.

31. The apparatus of claim 30, wherein said adder arrangement comprises an 8:2 carry-save adder to add a signal corresponding to said encoding constant value to seven signals corresponding to the remainder value corresponding to said cycle.

32. The apparatus of claim 30, wherein said encoding constant value comprises the value
$${\sum }_{j = 0}^{N} {2}^{1 - 2 j} ,$$
wherein N is a predetermined integer.

33. The apparatus of claim 26, wherein said quotient digit selector is able to generate at least two quotient digit bits in said division operation cycle.

34. A system comprising:
a processor including a quotient digit selector to generate a plurality of independent interim values by adding at least first and second sets of one or more carry bits of an encoded remainder value corresponding to a cycle of a division operation to at least first and second sets of one or more sum bits of said encoded remainder value, respectively; and to generate a plurality of coefficients corresponding to a quotient digit of said cycle based on said plurality of interim values; and
a memory associated with said processor and able to store one or more values corresponding to said division operation.

35. The system of claim 34, wherein said quotient digit selector comprises a quotient bit generator to generate one or more quotient digit bits corresponding to said quotient digit based on a combination of one or more of said plurality of coefficients.

36. The system of claim 34, wherein said quotient digit selector comprises at least first and second adders for generating said plurality of interim values by adding said at least first and second sets of carry bits to said at least first and second sets of sum bits, respectively.
